(19) United States
(12) Patent Application Publication
(10) Pub. No.: US 2006/0243564 A1
(43) Pub. Date: Nov. 2, 2006

(54) Conversion kit for a roller conveyor

(76) Inventor: Steffen Morch Holm, Lasby (DK)

Correspondence Address: PITNEY HARDIN LLP, 7 TIMES SQUARE, NEW YORK, NY, 10036-7311, US

(21) Appl. No.: 11/118,565

(22) Filed: Apr. 29, 2005

(51) Int. Cl. B65G 13/07

(52) U.S. Cl. 198/790

(57) ABSTRACT

The invention concerns a conversion kit for converting a non-driven roller conveyor for transporting objects in a transport direction into a driven roller conveyor, where the non-driven conveyor comprises a frame of at least two longitudinal flanged beams, braces interconnecting the longitudinal beams, and rollers placed between the beams. The conversion kit comprises a set of guide-pulleys, which are adapted to be clamped onto a flange on one of the longitudinal beams and two end-pulleys, which are adapted to be clamped onto two of the braces. In this way the guide-pulleys are fixated transversely to the transport direction, and the end-pulleys are fixated in the transport direction. The conversion kit can furthermore comprise a belt, tightening wheels, steering devices and a motor connected to a driving wheel and pre-mounted on a plate adapted to be placed between the two longitudinal flanged beams. The invention works by letting the belt be pushed up against the rollers and thereby driving these by frictional forces. The invention furthermore concerns a method for converting a non-driven roller conveyor into a driven roller conveyor by using a conversion kit as described above.

The present invention relates to a conversion kit for converting a non-driven roller conveyor used in transporting objects in a transport direction into a driven roller conveyor. The non-driven conveyor comprises a frame of at least two longitudinal flanged beams extending in the transport direction, two or more braces mounted between the beams transversely to the transport direction for interconnecting the longitudinal beams and rollers placed between the beams.

### BACKGROUND

In most industries there is a great need to transport parts or products around, e.g. from one station in the manufacturing process to the next, or when transporting the products or the materials into or out of a supply. If the transporting routes are more or less permanent, conveyors are often used to ease the transportation. A very simple and inexpensive conveyor is the gravity roller conveyor typically consisting of a number of rollers placed next to each other and supported by side beams in a frame. Driven conveyors can in many situations be advantageous over non-driven conveyors, both to increase the speed of the transportation of the products and to minimize the working load of the workers otherwise needing to push the objects along. The available space in a factory can furthermore be better exploited as the need for free space along the sides of the conveyors is removed, whereby the conveyors can be placed closer together. However, driven conveyors are often quite expensive. This together with the problem that a new driven conveyor may very well be of a different size, and thus incompatible with the already established transporting system, makes up two of the biggest obstacles for a manufacturer to automate the transporting system in his production. Also the need for automatic transportation at specific locations in a transporting system may change from time to time, naturally reducing the interest of the manufacturer to invest in the relatively costly driven conveyors. These concerns raise the need for a simple and fast but yet cost-efficient way to convert a non-driven conveyor into being driven and back again according to the specific need at a specific time and place.

In the patent JP7172529 is described a method to convert a non-driven gravity roller conveyor into a driven roller conveyor. Here, sets of an upper and a lower roller are placed at intervals, each set in between two of the old carrier rollers. The lower rollers are connected to a motor and are by friction used to drive the carrier rollers with which they are in contact. One disadvantage of this method is, however, that only some of the carrier rollers on the conveyor become driven, whereby an object of a length smaller than the distance between the driven rollers will not be transported. Furthermore, in order to apply the described method alterations must be made on the original conveyor (holes at specific locations and possibly strengthening of the supporting frame). Also, the parts to be mounted on the conveyor must be made with dimensions fitting the specific parameters of the conveyor at hand.

Another way of converting a non-driven conveyor is described in WO0132534 where a conversion kit can be applied to a roller conveyor turning this into a belt conveyor. The kit contains attachment collars that fit around selected rollers and are connected to wear strip material overlying a group of consecutive rollers. This then carries a motor driven conveying belt placed around the rollers. The conversion can be carried out quite fast, and a conveyor can easily be converted back again into its original state. However, several parts in the conversion kit still have to be dimensioned to the specific conveyor at hand. Another drawback of this method is that the converted conveyor takes up considerably more space than the original one, both in the transporting direction and in the width.

The patent U.S. Pat. No. 4,308,946 describes a gravity roller conveyor specifically designed to be turned into a driven one by applying an endless belt supported by a number of pulleys underneath the carrier rollers and which then drives the rollers by frictional forces. One of the end-pulleys is driven by a motor via a drive shaft. The end-pulleys are mounted on a center bracket disposed between the side frames supporting the rollers, and the guide-pulleys are mounted on tee bars hanging down from the side frames in between rollers at even distances. In order to be able to convert the conveyor into being driven, the construction of the basic conveyor becomes rather complicated and unnecessarily heavy. Furthermore, as was also the case with the invention described earlier, the conveyor has to be equipped with holes and threads for bolts at specific locations. Also, in this case a special design of the supporting frame is needed in order to make the conversion. The way the conveyor is made driven is thus far from being applicable to a general type of conveyor, but only to the specially designed conveyor described in the patent. This specialization further causes the cost of the basic non driven conveyor to be higher. Also the parts used to make the conversion must here be specially dimensioned to the specific conveyor, which is a disadvantage as manufactures often have conveyors of different models in the same transporting system.

### OBJECT AND SUMMARY OF THE INVENTION

It is therefore an object of the present invention to obtain a kit for converting a non-driven roller conveyor into a driven conveyor in only a few simple and fast operations. A further object is to obtain a kit, which is applicable on most models of roller conveyors with no or only small modifications on the parts in the kit.

The invention concerns a conversion kit for converting a non-driven roller conveyor for transporting objects in a transport direction into a driven roller conveyor, where the non-driven conveyor comprises a frame of at least two longitudinal flanged beams extending in the transport direction, two or more braces arranged transversely to the transport direction and interconnecting the longitudinal beams and rollers placed between the beams, and where the conversion kit comprises a set of guide-pulleys adapted to be clamped on a flange on at least one of said longitudinal beams, so that said guide-pulleys are fixated transversely to said transport direction and further two end-pulleys adapted to be clamped on said transverse braces, so that said end-pulleys are fixated in said transport direction.

A big advantage of the present invention is that the conversion kit can be applied on most conveyors without having to make time-consuming and costly modifications or preparations on the existing conveyor. Furthermore, no holes in the frame of the conveyor are needed to fasten the parts in the conversion kit, and the mounting is simple, fast and straightforward and can be done by a single not specially educated person and without cutting tools. The conversion kit as described above comprises only a minimum of mechanical parts, which are inexpensive to manufacture. Furthermore, the kit is advantageous in that the pulleys can be placed suitably anywhere along the length of the longitudinal beams, and transverse braces yet still provide the optimal support for a belt to drive the rollers of the conveyor. The conversion kit hence also works equally well on conveyors with unevenly placed rollers and on conveyors of varying widths and lengths.

The pulleys are both simple and fast to mount on the existing conveyor, and the transporting line does therefore not need to be stopped for long while the conveyor is made driven. Similarly the conversion kit can also be dismantled easily and fast, and the mechanical parts can be stored and reused as appropriate. By use of the described conversion kit it is in this way possible to convert a non-driven conveyor into being driven and back again according to the specific need for automatic transportation at a specific time and location.

In another embodiment of the invention a conversion kit according to the above further comprises an endless belt to be fitted around said guide-pulleys and said end-pulleys.

A conversion kit according to the above mentioned can in yet another embodiment further comprise a motor connected to a driving wheel and mounted on a plate adapted to be placed between the two longitudinal flanged beams, so that the motor is positioned within said frame and under said rollers. By positioning the motor within the frame of the conveyor the stability and the balance of the conveyor is not affected by the extra weight. As also is the case with the pulleys, the plate with the motor can be placed and mounted by very simple means anywhere along the length of the conveyor and hence on conveyors of different lengths.

Further, the end-pulleys in a conversion kit according the invention can be adapted to be clamped on a flange on at least one of the longitudinal beams, so that said guide-pulleys are fixated transversely to the transport direction. Hereby is obtained, that the end-pulleys by very simple means are kept fixed in all directions and thus provide optimal support of the belt.

A conversion kit according to the above can in a further embodiment also comprise at least one tightening wheel and/or at least one steering device which is adapted to be fastened onto at least one of the longitudinal beams, so that it is fixated transversely to said transport direction and/or a set of clips to set around at least a part of the longitudinal beams to keep the rollers supported by the beams. The tightening and steering wheels help to keep the belt in place and tightened in order to drive the rollers effectively.

The invention further refers to a method for converting a non-driven roller conveyor for transporting objects in a transport direction into a driven roller conveyor, where the non-driven conveyor comprises a frame of at least two longitudinal flanged beams extending in the transport direction, two or more braces transverse to the transport direction and interconnecting the longitudinal beams, and rollers placed between the beams. The method comprises the steps of:
clamping at least one guide-pulley onto a flange on at least one of said longitudinal beams, so that the guide-pulleys are fixated transversely to the transport direction,
clamping two end-pulleys onto the transverse braces, so that the end-pulleys are fixated in the transport direction,
fastening a plate which has a motor connected to a driving wheel pre-mounted thereon, between the two longitudinal flanged beams, so that the motor is positioned within the frame and under the rollers, and
fitting an endless belt around the guide-pulleys and the end-pulleys and the driving wheel.

This method of conversion is advantageous in the same ways as described previously for the conversion kit.

The method for converting a non-driven roller conveyor into a driven roller conveyor according to the present invention further comprises the further step of tightening the endless belt by adjusting the position of at least one tightening wheel.

Furthermore, the invention describes a method for converting a non-driven roller conveyor into a driven roller conveyor as described above, further comprising the step of clamping at least one of the end-pulleys to a flange on at least one of the longitudinal beams, so that the guide-pulley is fixated transversely to the transport direction.

In yet another embodiment the invention describes a method for converting a non-driven roller conveyor into a driven roller conveyor according to the above, further comprising the step of placing at least one clip around at least a part of at least one of the longitudinal beams, thereby preventing the rollers from being pushed upwards by the belt.

### BRIEF DESCRIPTION OF THE DRAWINGS

In the following preferred embodiments of the invention will be described referring to the figures, where:

FIG. 1 shows a simple gravity roller conveyor,

FIG. 2a shows a roller conveyor with one embodiment of a conversion kit according to the invention applied in a side view,

FIG. 2b shows the same roller as depicted in FIG. 2a in a top view,

FIG. 3 shows an embodiment of a mounted end-pulley and steering device in a closer view as seen from above,

FIG. 4 shows an embodiment of an end-pulley and steering device in a closer view as seen from the side,

FIG. 5 shows an embodiment of the plate with the motor assembly, driving and tightening wheels in a closer view as seen from above,

FIG. 6 shows the same as FIG. 5 but as seen from the side,

FIG. 7 shows an embodiment of a guide-pulley,

FIG. 8 shows an embodiment of an end-pulley,

FIG. 9 shows cross sectional views of different flanged beams with clamping means for pulleys,

FIG. 10 shows an embodiment of a plate with the motor assembly with adjustable width for mounting in between the two longitudinal side beams,

FIG. 11 shows a top view of a curved roller conveyor with parts of a conversion kit according to one embodiment of the invention, and

FIG. 12 shows a clip for retaining a roller in position.

### DESCRIPTION OF PREFERRED EMBODIMENTS

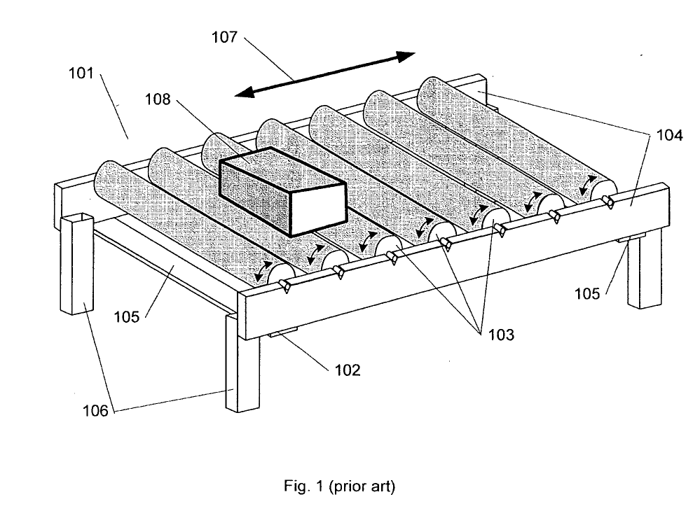

FIG. 1 shows a short non-driven gravity roller conveyor 101 consisting in its most simple case of a supporting frame 102 with a number of parallel rollers 103. The frame 102 comprises two longitudinal side beams 104 or side pieces, which support the rollers 103, two or more braces 105 interconnecting the beams 104, and a number of legs 106 which are often adjustable in the height. Objects 108 can be pushed along in the transport direction marked by the arrow 107. To obtain a strong frame with the maximum load capacity, but yet with a minimal use of material, the longitudinal side beams 104 are most often some sort of flanged beams such as L-profiles, I-profiles, or the like. The number of transverse braces 105 is kept to a minimum and most often simply consist of flat bars or profiles of some sort bolted or welded onto the side beams.

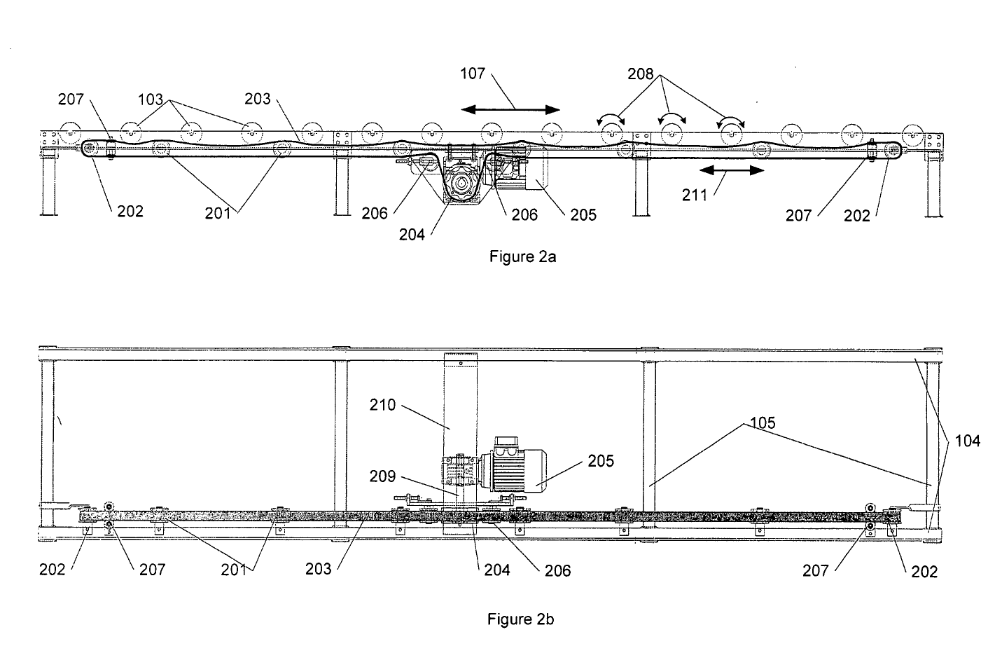

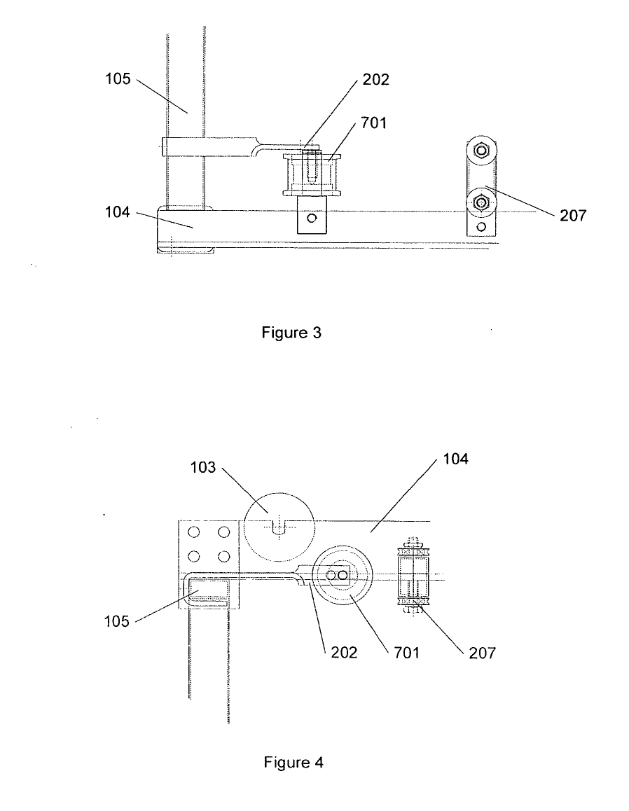

The present invention describes a conversion kit for turning a gravity roller conveyor, as for instance that depicted in FIG. 1, into a driven roller conveyor. In FIG. 2a-b is shown a top view and a side view, respectively, of a roller conveyor with a conversion kit according to one embodiment of the invention. Enlarged parts of the figure are also shown in the following FIGS. 3-6. The conversion kit basically comprises two end-pulleys 202 and a set of guide-pulleys 201. The kit can further comprise a belt 203 to be placed around the pulleys and a motor 205 connected to a driving wheel 204 for driving the belt 203. Optionally a toothed belt can be used instead of a belt. The principle used is thus to drive a plurality of the rollers 103 using friction. On the conveyer shown in FIG. 2a-b, the rollers are simply supported by two longitudinal flanged beams 104, which are interconnected with (in this case) four braces 105. The rollers 103 are for reasons of clarity only showed in the side view in FIG. 2b. Underneath the rollers 103 are placed a number of guide-pulleys 201 and two end-pulleys 202. Around the pulleys 201, 202 is placed a belt 203, which is driven by a driving wheel 204 connected to a gear-motor 205. The belt 203 is preferably tightened by one or more tightening wheels 206 in this embodiment placed closely to the driving wheel 204.

The positioning of the guide-pulleys 201 is such, that the rollers 103 are rotated as shown by the arrows 208 in FIG. 2a by frictional forces acting between the rollers 103 and the belt 203, which is being driven as shown by the arrow 209. Two steering devices 207 can be placed close to the end-pulleys 202 to help keeping the belt 203 in place.

A big advantage of the present invention is that the conversion kit can be applied on most conveyors without having to make time-consuming and costly modifications or preparations on the existing conveyor. Furthermore, no holes in the frame of the conveyor are needed to fasten the parts in the conversion kit and the mounting is simple, fast and straightforward and can be done by a single not specially educated person and without cutting tools.

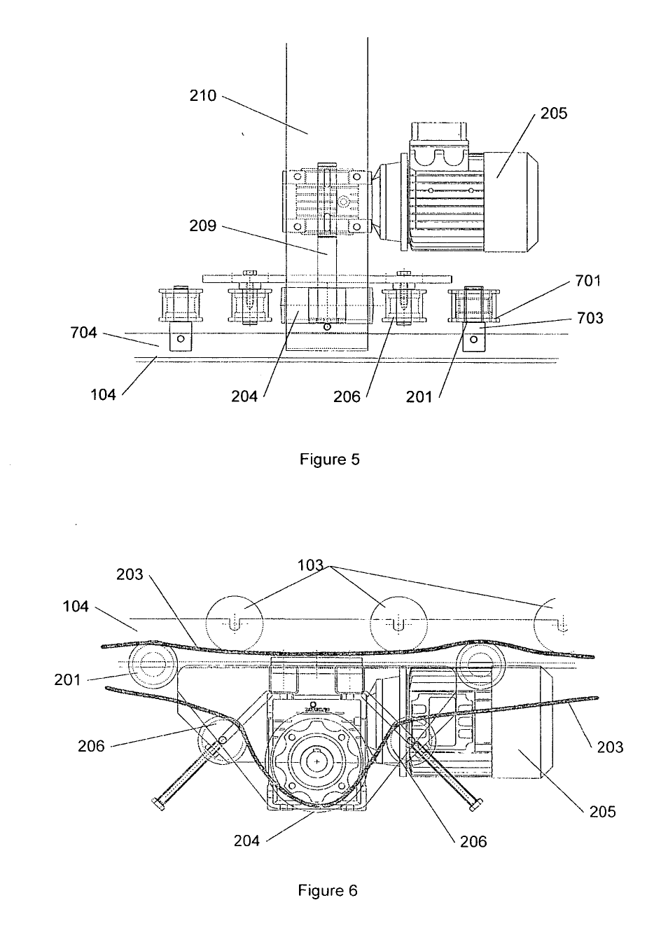

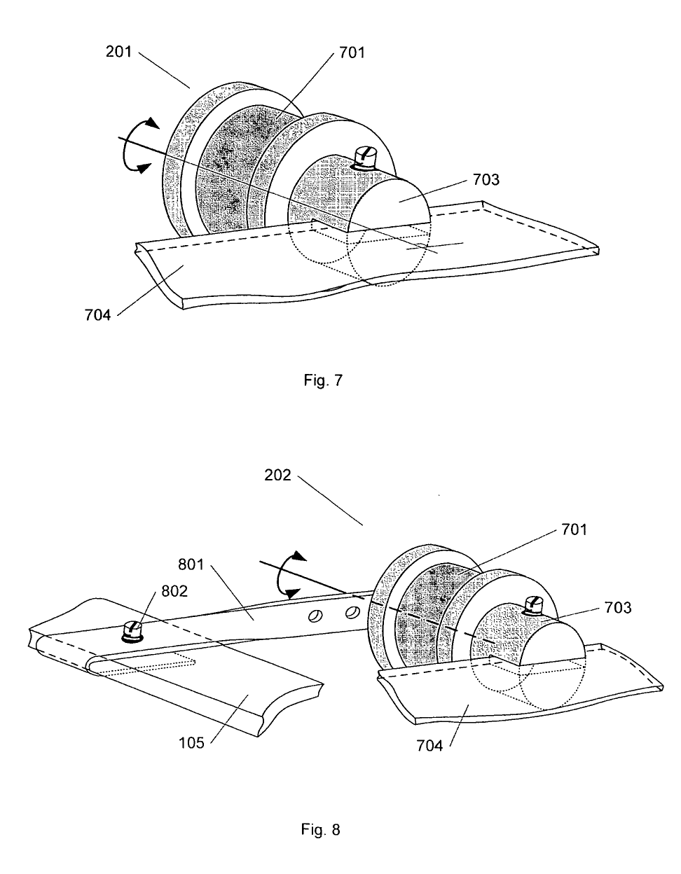

One feature of the conversion kit according to the present invention is the design of the guide-pulleys 201, which are constructed so that they can be clamped onto one of the longitudinal beams 104. A design of a guide-pulley according to one embodiment of the invention is depicted in more details in the FIGS. 5 and 7 described later. The guide-pulleys 201 are placed at intervals corresponding to placing of the carrier rollers 103 so that the belt 203 is supported optimally. In the embodiment shown in FIG. 2a-b the guide-pulleys 201 are placed at even intervals for every two carrier rollers 103. The guide-pulleys 201 are clamped to at least one of the flanged longitudinal beams 104 so that the guide-pulleys are fixated transversely to the transport direction and thus guide the belt optimally. The end-pulleys 202 are adapted to be clamped on two of the transverse braces 105 one in each end of the conveyor, so that the end-pulleys are fixated in the transport direction 107 and can take up the forces from the belt in that direction. An embodiment of an end-pulley 202 and its mounting is shown in more details in the following FIGS. 3, 4, and 8. The belt 203 is driven by a driving wheel 204 connected to a gear-motor 205 by a shaft 209. One or two tightening wheels 206 can be placed nearby the driving wheel 204 as shown in the FIG. 2a and in greater detail in the FIGS. 5 and 6. The belt can be tightened by moving and fastening the tightening wheels 206 in slots. The assembly of the driving wheel 204, the tightening wheels 206 and the motor is pre-mounted on a plate 210 of a length corresponding to the distance between the longitudinal beams 104. The plate 210 is then simply clamped onto the two longitudinal beams 104 without the need for any cutting tools.

An enlarged portion of an end section of a conveyor as the one shown in FIG. 2a-b is depicted in FIGS. 3 and 4 in a top and side view, respectively. The belt is not shown for clarity. Here an end-pulley 202 is fastened on a brace 105 by a bended fitting going partly around the brace. The end-pulley can further be fastened to one of the longitudinal beams 104 similarly to that of the guide-pulleys. Hereby the end-pulley is firmly fixated in all directions. A steering device 207 is placed close to the end-pulley 202 to help guiding the belt and keeping it in place. The end-pulley 202 here comprises a wheel 701 free to rotate, but in another embodiment the belt could also simply by guided around a fixed cylinder.

In FIG. 5 and 6 is shown an enlarged top view and side view, respectively, of the driving unit also depicted in FIG. 2a and b. The belt 203 (only sketched in FIG. 6 for reasons of clarity) is driven by a driving wheel 204 connected to a gear-motor 205 by a shaft 209. One or two tightening wheels 206 can be placed nearby the driving wheel 204, and the belt can be tightened by moving and fastening the tightening wheels 206 in slots. The assembly of the driving wheel 204, the tightening wheels 206 and the motor is pre-mounted on a plate 210 of a length corresponding to the distance between the longitudinal beams 104. The plate 210 is then simply clamped onto the two longitudinal beams 104 without the need for any cutting tools. A couple of guide-pulleys 201 can also be seen in FIG. 5. The guide-pulleys 201 should be placed at intervals corresponding to the placing of the carrier rollers 103, so that the belt 203 is supported optimally. In the design of the guide-pulleys shown here, a guide-pulley 201 simply comprises a wheel 701 on a fitting 703 for fastening on a flange 704 of a beam 104.

This is also sketched in more details in the following FIG. 7. As shown here a guide-pulley 201 simply comprises a wheel 701 on a fitting with fastening means 703 for fastening on a flange 704 of a beam 104. The design of the fastening means 703 of a guide-pulley is such that each pulley is fixated transversely to the transport direction and thus guides the belt optimally. In one embodiment of a guide-pulley the fastening means 703 further is designed so that the guide-pulley will be oriented orthogonally to the length of the beam when the guide-pulley is pushed up against the part 704 of the beam onto which it is fastened. This is advantageous in that it facilitates the mounting of the pulleys, helps to ensure a correct fastening with the best possible guiding of the belt and decreases the time needed for converting a conveyor. In another embodiment a guide-pulley 201 comprises a fixed cylinder instead of the rotating wheel. This will increase the friction between the moving belt and the guide-pulley and probably cause increased wear of the belt, but the guide-pulley would, however, still provide the necessary support of the belt.

In FIG. 8 is shown an embodiment of an end-pulley 202 and its mounting. An end-pulley 202 is adapted to be clamped on a transverse brace 105, so that the end-pulley is fixated in the transport direction and can take up the forces from the belt in that direction. In the embodiment shown here the end-pulley 202 comprises a wheel 701 on a fitting 801 for fastening on a brace 105, which in this example consists of a flat bar. The fastening is here simply obtained by a bended fitting 801 going around and optionally being tightened to the brace 105 by a screw 802. The end-pulley can further be fastened to one of the longitudinal beams by a fitting 703 similarly to that of the guide-pulleys. Hereby the end-pulley is firmly fixated in all directions.

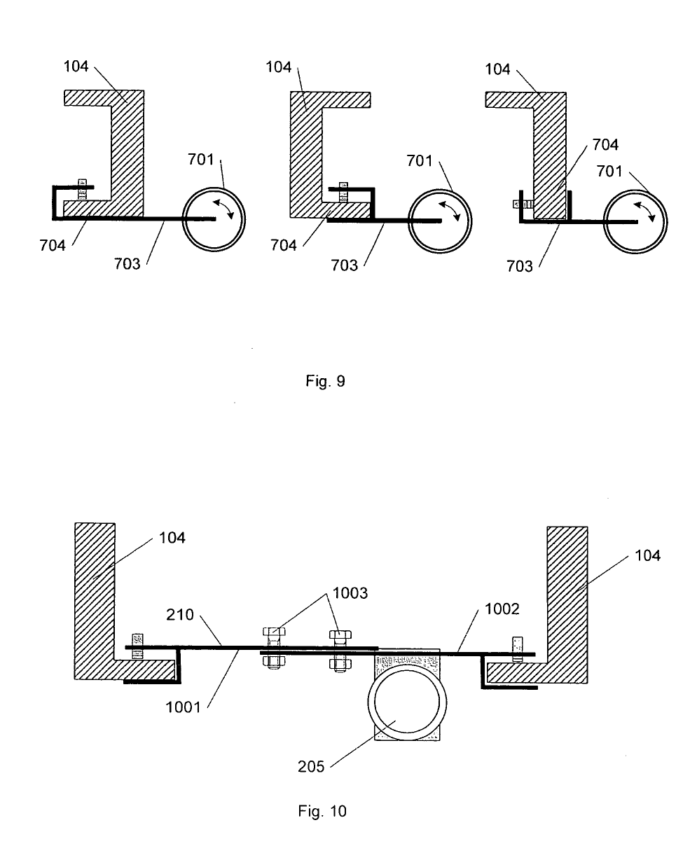

The fittings and fastening means 703 of the guide- and end-pulleys 201, 202 can be designed in different ways to comply with different possible shapes of the longitudinal beams 104 used in the original conveyor. Such different designs are sketched in FIG. 9. Different types of beam profiles such as inwards and outwards L-profiles, I-profiles and T-profiles are shown in hatched cross-sectional views with different embodiments of the fittings and fastening means 703 for the pulleys. In all embodiments the pulleys are clamped or tightened onto a flange 704 of the beams 104. In this way the pulleys can be placed anywhere convenient along the length of a beam and in accordance with the placement of the rollers, and without the need of specially placed holes. Furthermore, the pulleys can be mounted on a conveyor in a simple and fast way without the need for cutting tools. In the figures shown previously the rotating axis of the pulley wheels 701 is kept at more or less the same vertical height as the lower side of the beams 104. Depending on the dimensions of the beams, or if it is desirable for the efficiency of the driving kit to have the belt 203 placed closer to or further apart from the rollers 103, this is easy and straightforward to obtain by simply changing the diameter of the pulley wheels 701 or by making a bend on the fitting part 703 leading to the wheel 701.

The plate 210 supporting the motor assembly 205 can have different fastening means similarly to the guide-pulleys 201 shown in the above FIG. 9. Thus, the plate 210 can likewise be designed according to different profile types of the longitudinal side beams 104. In FIG. 10 is sketched how the plate 210 in one embodiment further can be made as to be easily adjusted to conveyers of different width. In the embodiment shown, the plate 210 simply consists of two plates 1001 and 1002 bolted together and where at least one of the plates is equipped with slits for the fastening bolts 1003 instead of holes, whereby the position of the plates relative to each other can be adjusted to fit to the width of the conveyor.

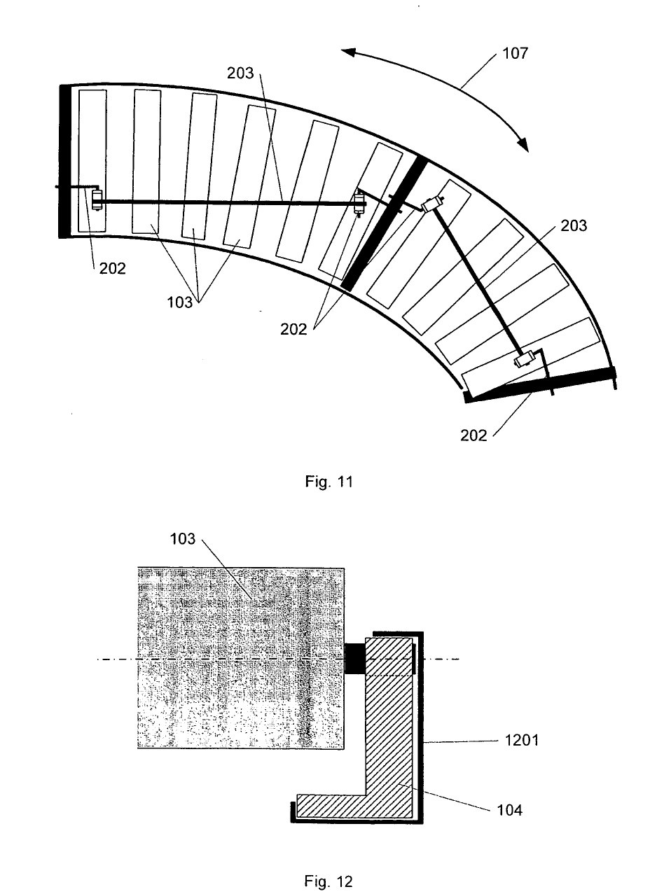

The conversion kit according to the present invention can be used on roller conveyors of all different types and is not in any way restricted to be applied only on straight conveyors with parallel evenly distributed rollers of equal dimensions. In FIG. 11 is shown a top view of a curved roller conveyor where the transport direction 107 changes along the length of the conveyor. In the figure is sketched how the conveyor could be converted into a driven conveyor by use of the present invention. In this example two belts 203 and two sets of guide- and end-pulleys are used. Only the end-pulleys 202 are shown for simplicity. The two belts 203 could be driven by the same motor (not shown). In order to obtain straight belts, the guide-pulleys are equipped with fitting parts connecting the wheel parts to the fastening parts of the pulleys of different lengths according to the position of the pulley along the length of the conveyor.

In some roller conveyor models the rollers 103 rest simply supported in bearings or notches in the longitudinal beams 104. When the conversion system is applied to the conveyor, the forces from the belt 203 can push the rollers upwards and cause them to leave their bearings. To avoid this, a conversion kit according to the present invention can comprise a set of clips 1201 to keep the rollers 203 in position as sketched in FIG. 12. A clip 1201 is placed partly around the beam 104 at each end of each roller closing the notch in which the roller 103 is supported. The clip can for example be made of a thin steel plate yielding the necessary strength and stiffness to be pressed around the beam 104 in a simple and effortless operation without any tools necessary.

In one embodiment the conversion kit can be applied to an existing conveyor by first removing all the rollers 103 belonging to said conveyor. The rollers are often just loosely supported by the longitudinal beams 104, so the rollers are normally easy and fast to remove. Then the plate 210 onto which is preassembled the motor 205 with the shaft 209 to the driving wheel 204 and the tightening wheels 206 is fastened. This assembly is placed in between the longitudinal beams 104 within the frame 102 of the conveyor and underneath the rollers 103. A placing within the frame ensures the maintenance of the stability of the driven conveyor. Then the belt 203 is placed around the driving 204 and tightening wheels 206 and around the end-pulleys 202 which are then fastened to a transverse brace 105 in every end of the conveyor thus being fixated in the transport direction 107. Next, the end-pulleys 202 can—if designed like that—be fastened onto a flange on one of the longitudinal side beams 104 in the same way as the guide-pulleys 201, which are placed at regular intervals down the length of the side beams 104 and in between the rollers 103 as for instance seen in FIG. 2a. If the conversion kit contains steering devices 207 these are then mounted next, not far from the end-pulleys 202. The belt 203 is fitted around all the pulleys 201, 202 and the steering devices 207 and finally tightened by adjusting the position of the tightening wheels 206. Finally, the rollers 103 are remounted on the conveyor. If these are loosely supported by the side beams 104, clips 1201 can be put around the side beams 104 holding the rollers 103 in place and preventing them from being pushed up by the tightened driving belt 203 just underneath. The conveyor is hereby converted into a driven roller conveyor. If the transporting situation changes and the driven conveyor for some reason is no longer needed the conversion kit can simply be dismantled and stored for later use on another conveyor. As also mentioned earlier the kit described by this invention is advantageous in being simple and fast to mount on a conveyor without any special tools or special preparations.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim.

1. A conversion kit for converting a non-driven roller conveyor for transporting objects in a transport direction into a driven roller conveyor, where the non-driven conveyor comprises a frame of at least two longitudinal flanged beams extending in the transport direction, two or more braces arranged transversely to the transport direction and interconnecting the longitudinal beams, and rollers placed between the beams, and where the conversion kit comprises:
a set of guide-pulleys adapted to be clamped on a flange on at least one of said longitudinal beams, so that said guide-pulleys are fixated transversely to said transport direction, and
two end-pulleys adapted to be clamped on said transverse braces, so that said end-pulleys are fixated in said transport direction.

2. A conversion kit according to claim 1, further comprising an endless belt to be fitted around said guide-pulleys and said end-pulleys.

3. A conversion kit according to claim 1, further comprising a motor connected to a driving wheel and mounted on a plate adapted to be placed between said two longitudinal flanged beams, so that the motor is positioned within said frame and under said rollers.

4. A conversion kit according to claim 1, where said end-pulleys further are adapted to be clamped on a flange on at least one of said longitudinal beams, so that said guide-pulleys are fixated transversely to said transport direction.

5. A conversion kit according to claim 1, further comprising at least one tightening wheel.

6. A conversion kit according to claim 1, further comprising at least one steering device adapted to be fastened onto at least one of said longitudinal beams, so that said steering device is fixated transversely to said transport direction.

7. A conversion kit according to claim 1, further comprising a set of clips to set around at least a part of said longitudinal beams to keep said rollers supported by said beams.

8. A method for converting a non-driven roller conveyor for transporting objects in a transport direction into a driven roller conveyor, where the non-driven conveyor comprises a frame of at least two longitudinal flanged beams extending in the transport direction, two or more braces transverse to the transport direction and interconnecting the longitudinal beams, and rollers placed between the beams and where the method comprises the steps of:
clamping at least one guide-pulley onto a flange on at least one of said longitudinal beams, so that said guide-pulleys are fixated transversely to said transport direction,
clamping two end-pulleys onto said transverse braces, so that said end-pulleys are fixated in said transport direction,
fastening a plate which has a motor connected to a driving wheel pre-mounted thereon, between said two longitudinal flanged beams, so that said motor is positioned within said frame and under said rollers, and
fitting an endless belt around said guide-pulleys and said end-pulleys and said driving wheel.

9. A method for converting a non-driven roller conveyor into a driven roller conveyor according to claim 8, further comprising the step of tightening said endless belt by adjusting the position of at least one tightening wheel.

10. A method for converting a non-driven roller conveyor into a driven roller conveyor according to claim 8, further comprising the step of clamping at least one of said end-pulleys to a flange on at least one of said longitudinal beams, so that said guide-pulley is fixated transversely to said transport direction.

11. A method for converting a non-driven roller conveyor into a driven roller conveyor according to claim 8, further comprising the step of placing at least one clip around at least a part of at least one of said longitudinal beams thereby preventing said rollers from being pushed upwards by said belt.
